(19) United States
(12) Patent Application Publication
(10) Pub. No.: US 2026/0243792 A1
(43) Pub. Date: Aug. 20, 2026

(54) PROBE CLEANING SYSTEM AND METHOD

(71) Applicant: Bio-Rad Laboratories, Inc., Hercules, CA (US)

(72) Inventors: Chihhung Chris TSAI, San Ramon, CA (US); Shrevatsan VENKATESAN, San Ramon, CA (US); Roberto Carlos SALINAS, Napa, CA (US); Tanner FEUSTEL, Pleasant Hill, CA (US); Varun Mitesh SHAH, Concord, CA (US); Rafael DIAZ, Jr., Fairfield, CA (US); Joshua-Noel PEREZ, Fairfield, CA (US); Glenn Leo PRICE, Martinez, CA (US)

(21) Appl. No.: 19/164,541

(22) PCT Filed: Mar. 1, 2024
(86) PCT No.: PCT/US2024/018002

§ 371 Date: Sep. 11, 2025

Related U.S. Application Data
(60) Provisional application No. 63/452,010, filed on Mar. 14, 2023.

(51) Int. Cl. G01N 35/10

(52) U.S. Cl. CPC G01N 35/1004

(57) ABSTRACT

A probe cleaning system and method including multiple pressurized sources and a valve that are configured for cleaning a probe. The valve includes multiple inlet channels, an outlet channel, and a selector. Each inlet channel can be connected to a specified pressurized cleaning source of the multiple pressurized cleaning sources. The plurality of inlet channels are isolated from each other to avoid cross-contamination. The selector can be configured to open a specified inlet channel to pass one specified pressurized cleaning source to the outlet channel at a specified time. The probe can be coupled to the outlet channel of the valve to receive the specified pressurized cleaning source when the specified inlet channel of the valve is opened during a cleaning cycle.

### CROSS REFERENCES TO RELATED APPLICATIONS

The present application claims priority to U.S. Provisional Patent Application No. 63/452,010 filed Mar. 14, 2023, the full disclosure of which is incorporated herein by reference in their entirety for all purposes.

### FIELD OF DISCLOSURE

Generally, the present disclosure relates to a system and method for probe cleaning. More particularly, the cleaning system uses pressurized wash buffers, air pulses, and/or NaOH supply to facilitate fast cleaning time while conserving cleaning supplies.

### BACKGROUND

Probe may deliver aliquots from successive sample containers such as blood collection tubes or liquid reagent vessels. As a probe sequences between one or more sample containers, carryover or contamination between samples can occur. To avoid intra-sample contamination or carryover, the probe is flushed with a diluent liquid (e.g., water) or wash buffer.

An automated system for diagnostic assays can include a liquid handling probe such as an open-ended pipetting probe coupled to a motor-driven syringe-type pump. The probe can be moved between different containers containing same or different samples. The probe can be lowered into a first liquid held in a first container and a specified volume of liquid can be drawn into the probe by operating the syringe-type pump. The probe filled with the first liquid can be withdrawn from the first container and moved to a position above or within a second container such as a reaction cuvette or cell. Then, the syringe-type pump can be operated again to dispense the first liquid from the probe into the reaction cell. During such transfer, for example, a first reagent may be transferred by the probe from the first container (e.g., a reagent storage container) to a reaction cell. During a subsequent liquid transfer operation, a second different reagent may be transferred by the same probe from a second reagent container to the reaction cell. Traces of the first reagent may remain in or on the probe and be carried over to and contaminate the second reagent as it is drawn into and expelled from the probe during the second transfer operation. Such carryover can result in errors in the analysis of samples. As such, the probe should be washed to prevent cross-contamination of samples.

### BRIEF SUMMARY

A probe used to transfer samples in a lab during a procedure (e.g., diagnostic assays) can be reused several times in the procedure. The probe should be cleaned or washed internally and externally reduce carryover or inter-sample contamination. Such probe cleaning involves cleaning with different cleaning supplies. However, existing probe wash or clean systems use multiple single valves and/or syringe pumps forming a complicated configuration. Such configuration requires activating multiple valves and syringe pumps to complete a cleaning process (e.g., wash sequence involving alternating between different cleaning sources). This can increase cleaning time and reduce throughput of a procedure e.g., a diagnostic analysis, chemical analysis, etc. To improve the cleaning time and throughput, a plurality of pressurized cleaning sources are used which can be directed to the probe using a single valve, according to various embodiments.

One aspect of the present disclosure relates to a probe cleaning system including a plurality of pressurized cleaning sources, and a valve coupled to the pressurized cleaning sources so that the cleaning or washing of a probe can be completed in a specified time period (e.g., less than 3 s). The plurality of pressurized cleaning sources can be pressurized at a specified pressure to save time associated with activating or deactivating a pump to push a cleaning source through a source. The valve can include a plurality of inlet channels, an outlet channel, and a selector. Each inlet channel can be connected to a specified pressurized cleaning source of the plurality of pressurized cleaning sources. The plurality of inlet channels can be isolated from each other. The selector can be configured to open a specified inlet channel to pass one specified pressurized cleaning source of the plurality of pressurized cleaning sources to the outlet channel at a specified time. The probe can be coupled to the outlet channel of the valve to receive the specified pressurized cleaning source when the specified inlet channel of the valve is opened during a cleaning cycle.

In many embodiments, the plurality of pressurized cleaning sources can include one or more wash buffers, and a compressed air supply. The plurality of pressurized cleaning sources further comprises an NaOH supply. The compressed air supply can be coupled to each of the plurality of pressurized cleaning sources to drive the specified pressurized cleaning source through the specified inlet channel. The compressed air supply can be directly fluidically coupled to multiple of inlet channels. The compressed air supply can be configured to pulse air through the probe at a specified pulse rate.

In many embodiments, the selector can be configured to receive a sequence of cleaning sources selected from the plurality of the pressurized cleaning sources to be supplied to the probe during the cleaning cycle. The selector is configured to open one inlet channel at a time while closing other inlet channels so as to avoid intermixing of the plurality of cleaning sources. Each cleaning source of the sequence of cleaning sources can be activated at a specified time so that an entire sequence of cleaning sources is completed within a specified time period. The specified time period of the cleaning cycle can be less than 3 seconds. In many embodiments, the inlet channels of the valve has minimum dead volume configured such that one pressurized cleaning source can be prevented from leaking in another pressurized cleaning source when the valve switches between the plurality of pressurized cleaning sources. In many embodiments, the valve can be a rotary valve. The rotary valve can include the plurality of inlet channels and the selector drivable via a motor.

The probe can include a lumen, and one or more of the pressurized cleaning sources can be passed through the lumen of the probe to clean an interior of the probe. The probe can include a tip portion for receiving a sample, and a tail portion extending away from the tip portion. The specified cleaning source of the plurality of pressurized cleaning sources can be receivable from the tail portion, and exit from the tip portion during the cleaning cycle.

In many embodiments, the system can further include a wash container in which the probe can be washed or cleaning sources can be drained. The wash container can include a vacuum well configured to receive the probe and suck away the specified pressurized cleaning source dispensed from the probe causing interior cleaning of the probe. In some embodiments, the vacuum has a pressure range of −20 kPa +/−2 kPa. The wash container can also include a side well that can be positioned adjacent to the vacuum well and configured to clean an exterior portion of the probe.

In many embodiments, the system can further include a manifold to direct a pressurized cleaning source to the probe. The manifold can include a first channel coupled to the outlet channel of the valve and direct the specified pressurized cleaning source to the probe, and a second channel isolated from the first channel.

In some embodiments, the system can further include an aspiration-dispense comprising a piston pump and a wash buffer. The second channel of the manifold can be coupled to the piston pump to direct wash buffer into the probe or receive suction pressure to aspire a sample into a tip portion of the probe.

Another aspect of the present disclosure relates to a method of probe cleaning at a clean station using a probe cleaning system. As mentioned, the probe cleaning system can include a plurality of pressurized cleaning sources including a pressurized wash buffer and a compressed air supply, a valve with a plurality of isolated inlet channels including a first inlet channel coupled to the pressurized wash buffer and a second inlet channel coupled to the compressed air supply, and a selector to open or close a specified inlet channel. The method can involve inserting a probe in a vacuum well of a wash container at the clean station; applying suction to the vacuum well to remove a residual sample in a lumen of the probe for a first time period; supplying the pressurized wash buffer into the lumen of the probe by opening, via the selector, the first inlet channel of the valve for a second period of time; and pulsating the compressed air supply into the lumen of the probe by opening, via the selector, the second inlet channel of the valve for a third period of time.

In some embodiments, the method can further include subsequent to pulsating of the compressed air supply, resupplying the pressurized wash buffer into the lumen of the probe by opening the first inlet channel of the valve for a fourth period of time; and withdrawing the probe from the wash container. In some embodiments, the method can further include subsequent to pulsating of the compressed air supply or subsequent to supplying the pressurized wash buffer, supplying a pressurized NaOH into the lumen of the probe by opening a third inlet channel of the valve for a fifth period of time.

In some embodiments, the method can further include subsequent to cleaning the probe, activating an aspiration dispense system coupled to the valve, the aspiration dispense system comprising a piston pump coupled to a fourth inlet channel of the valve; and aspirating a specified amount of sample from a sample container into the lumen of the probe by opening the fourth inlet channel or through a manifold, and activating the piston pump. In some embodiments, activating the aspiration dispense system can include closing, via the selector, all the inlet channels of the valve before aspirating the specified amount of sample.

In some embodiments, the method can further include supplying another wash buffer into the lumen of the probe via the piston pump, wherein the another wash buffer is coupled to the piston pump. Supplying the another wash buffer can include activating the compressed air supply of the probe cleaning system to drive the another wash buffer through the piston pump and the valve into the lumen of the probe. The compressed air supply is coupled to the another wash buffer. The sample can be held in a tip portion of the probe and a wash buffer occupies a remaining portion of the probe so that an entire lumen of the probe is not contaminated with the sample.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying figures are for illustration purposes only and can or cannot represent actual or preferred values or dimensions. Where applicable, some or all features cannot be illustrated to assist in the description of underlying features. In the drawings:

FIG. 1 is a block diagram of a probe cleaning system, in accordance with some embodiments of the present disclosure.

FIG. 2A is an example rotary valve used in the probe cleaning system of FIG. 1.

FIG. 2B is another example rotary valve used in the probe cleaning system of FIG. 1.

FIG. 2C-2E illustrate example connections of inlets to an outlet of the rotary valve of FIG. 2B.

FIG. 3A is an example manifold used in the probe cleaning system of FIG. 1.

FIG. 3B is a top view of a section of another example manifold used in the probe cleaning system of FIG. 1.

FIG. 4 (a)-(c) illustrate example sequence of probe cleaning using the probe cleaning system of FIG. 1.

FIG. 5 (a)-(e) illustrate another example sequence of probe cleaning using the probe cleaning system of FIG. 1.

FIG. 6 is a flow chart of a method of cleaning a probe using the system of FIG. 1.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A probe may be reused to deliver aliquots from successive sample containers. In order to reduce carryover or inter-sample contamination, the probe can be cleaned or washed internally and externally. For example, the washing process includes dipping the open-end portion of the probe into a wash container filled with a suitable cleaning liquid, such as deionized water or wash buffer. The cleaning liquid may be circulated around an exterior of the probe to more thoroughly cleanse the probe exterior. Similarly, cleaning liquid can be passed through the probe to remove carryover substances (e.g., a sample) within a lumen of the probe. However, existing probe wash or clean systems use multiple single valves and/or syringe pumps forming a complicated configuration. Such configuration requires activating multiple valves and syringe pumps to complete a cleaning process (e.g., wash sequence involving alternating between different cleaning sources). This can be a time consuming process which reduces throughput of assays. Additionally, use of multiple syringe pumps and valves can make trouble shooting challenging and time consuming. Several systems aspirate a cleaning liquid (e.g., wash buffer etc.) from a reservoir, which increases probe cleaning time and reduces throughput of assays. This limits the number of assays that can be performed within a given time period. Furthermore, some syringe pumps operate at different pressure levels, which requires extra steps of adjusting pressure levels thereby adding to the probe cleaning time. An extra wash buffer may be used to increase throughput, but this comes at an expense of additional storage space and costs.

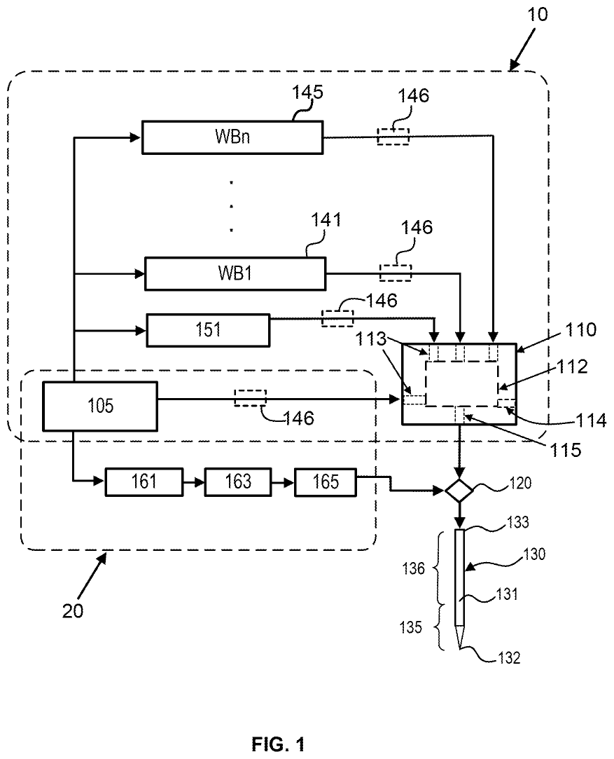

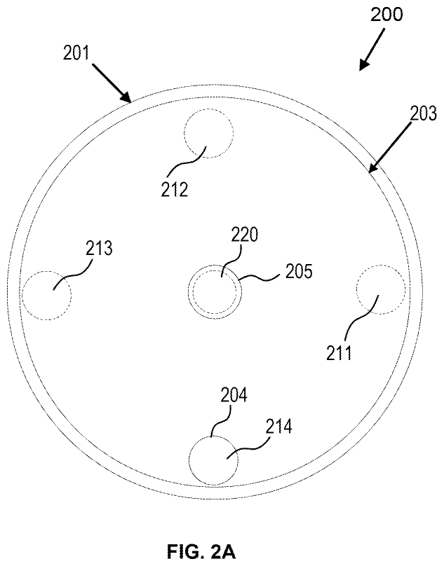

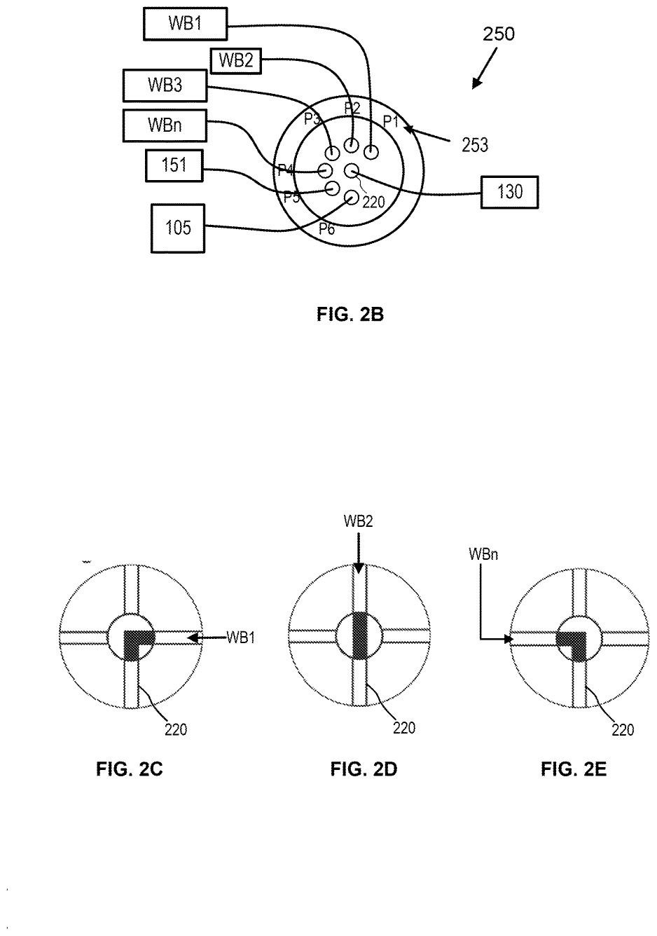

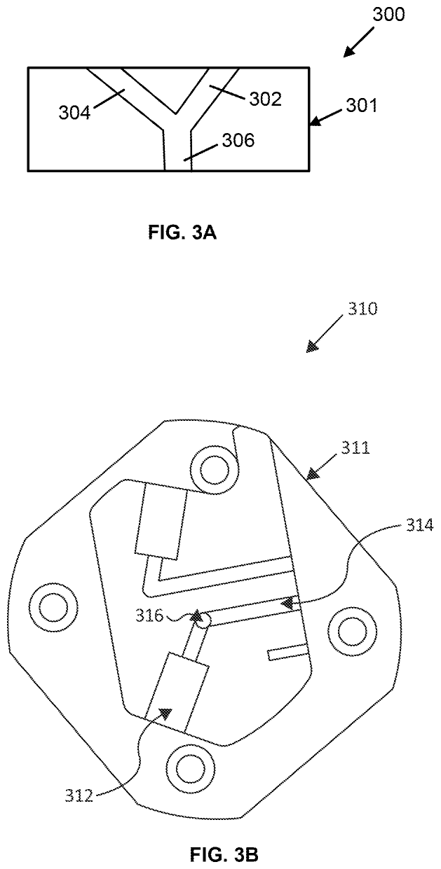

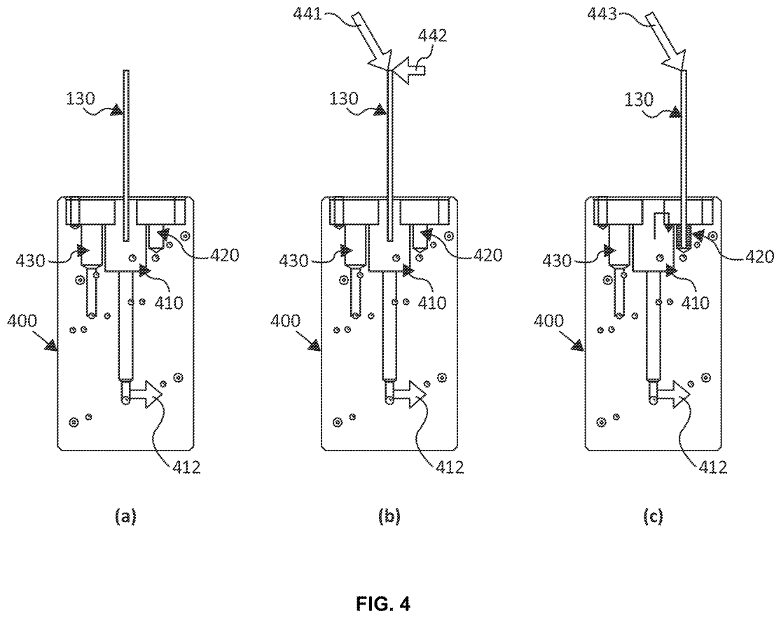

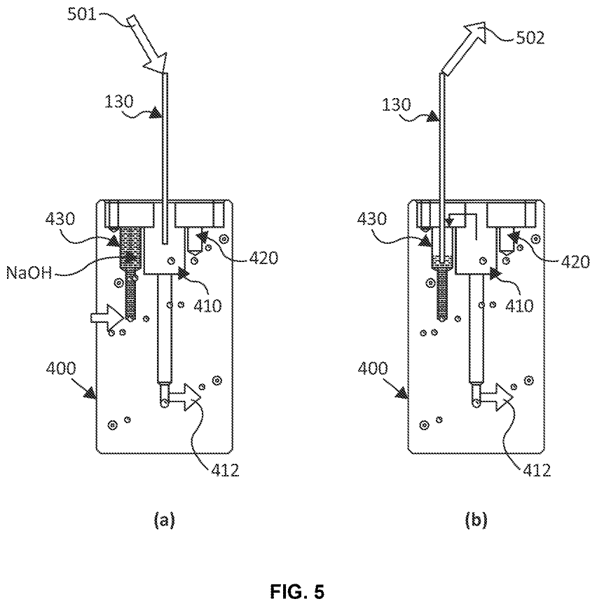

FIG. 1 is a block diagram of a probe cleaning system 10 for cleaning a probe 130. The probe cleaning system 10 can include multiple pressurized cleaning sources (e.g., 105, 141, 145, 151), a valve 110, and a probe 130 receiving one or more of the cleaning sources via the multiple inlet valve 110. In many embodiments, the valve 110 is a multiple inlet valve, each inlet coupled to a particular pressurized cleaning source of the pressurized cleaning sources (e.g., 105, 141, 145, 151). In many embodiments, the probe cleaning system 10 can be configured to provide one cleaning source at a time to a probe 130 in a specified sequence such that the probe 130 can be washed within a specified time (e.g., less than 3 seconds). The probe cleaning system 10 can facilitate probe wash at a faster rate than existing probe wash systems because a single valve can individually supply different pressurized cleaning sources thereby improving throughput of diagnostics assays. For example, in many embodiments, the probe cleaning system 10 can be configured to wash the probe 130 internally by selectively supplying a specified cleaning source (e.g., 105, 141, 145, and 151) via the single valve (e.g., the multiple inlet valve 110). Using single valve and pressurized cleaning sources saves time and facilitates faster probe wash compared to probe wash systems that require activation of multiple valves or pumps. In some embodiments, the probe cleaning system 10 can also be configured to wash the probe 130 externally, e.g., using a wash container (e.g., see FIG. 2A and FIG. 3A).

In many embodiments, the plurality of pressurized cleaning sources (e.g., 141, 145, 151, and/or 105) may include one or more wash buffers, a compressed air supply 105, an NaOH supply or other wash sources. The present disclosure does not limit the cleaning sources to ones listed herein and other sources are possible. The pressurized cleaning sources may be in liquid or gas form. In the illustrated embodiments, the pressurized cleaning sources 141, 145 may be a first wash buffer WB1, a second wash buffer, . . . , and/or an nth wash buffer WBn. The pressurized cleaning source 151 can be an NaoH supply, and the pressure cleaning source 105 can be a compressed air supply 105. A pressurized cleaning source can be pre-pressurized at a specified pressure so that a specified cleaning source can be directed to the probe 130 without a need to activate an additional pump thereby saving time during probe washing. For example, the pressurized cleaning source can be within a pressure range 30 kPa-50 kPa.

In many embodiments, the compressed air supply 105 can be coupled to each of the plurality of pressurized cleaning sources to drive the specified pressurized cleaning source 151, the wash buffers WB1, . . . , WBn through a specified inlet channel of the multiple inlet valve 110. In some examples, a pressurized cleaning source may be pressurized by the compressed air supply 105. As illustrated in FIG. 1, the compressed air supply 105 can serve as a common pressure source to different cleaning sources. Having a common compressed air supply saves space within a clean station at which probe wash can be performed. Additionally, the compressed air supply 105 can be directly fluidically coupled to an inlet of the multiple inlet valve 110. The compressed air supply 105 can be configured to pulse air through a lumen 131 of the probe 130 at a specified pulse rate so that remaining sample, wash buffer (e.g., WB1, WBn, etc.) can be dispensed through an open end of the probe 130. As an example, the compressed air supply 105 can be fluidically coupled using pipes such as flexible pipes so that the probe 130 can be moved around between a clean station and a sample station.

In many embodiments, the valve 110 can be a multiple inlet valve coupled to the multiple pressurized cleaning sources (e.g., 105, 141, 145, 151) at an input side and to the probe 130 coupled at an output side. The valve 110 can be configured to receive an activation signal to selective allow a pressurized cleaning source into the probe 130. The valve 110 can include a plurality of inlet channels 113 to receive the pressurized cleaning sources, an outlet channel 115 to deliver a specified cleaning source to the probe 130, and a selector 112 to selectively direct a specified pressurized cleaning source to the outlet channel 115. In some embodiments, the valve 110 may include a blocked inlet port 114 to block the inlets from the outlet so that the probe 110 is not receiving any cleaning source. Each inlet of the valve 110 can be coupled to a particular pressurized cleaning source of the pressurized cleaning sources (e.g., 105, 141, 145, 151), as shown in FIG. 1. The inlet channels 113 of the valve 110 has negligible to zero dead volume configured such that one pressurized cleaning source (e.g., 141) is prevented from leaking in another pressurized cleaning source (e.g., 151) when the valve switches between the plurality of pressurized cleaning sources (e.g., 141 to 151). The valve 110 can be a rotary type valve (e.g., further discussed with respect to FIG. 2A-2E), a sliding type of valve, or other valve types.

In many embodiments, a cleaning or wash process involves washing the probe 130 using one or more cleaning sources in a specified sequence (e.g., Air followed by WB1 followed by NaOH followed by WB1 and followed by air). Each cleaning source of the sequence of cleaning sources can be activated at a specified time so that an entire sequence of cleaning sources is completed within a specified time period. As an example, the selector 112 can be activated to switch between the pressurized cleaning sources so that a compressed air 105 can be activated at time t1, the wash buffer WB1 can be activated at time t2, the NaoH supply 151 can be activated at time t3, and again the compressed air 105 can be activated at time t4. A specified time period of a cleaning cycle can be less than 3 seconds.

In many embodiments, the probe 130 can be coupled to the outlet channel 115 of the valve 110 to receive the specified pressurized cleaning source (e.g., WB1, NaoH, or air) when the specified inlet channel of the valve 110 is opened during a cleaning cycle. In many embodiments, the probe 130 can include a lumen 131 to be washed. One or more of the pressurized cleaning sources (e.g., 105, 141, 145, 151) can be passed through the lumen of the probe to clean an interior of the probe 130. The probe 130 can include a tip portion 135 for receiving a sample (not illustrated), and a tail portion 136 extending away from the tip portion 135. The tip portion 135 has a distal end (e.g., a tip of a tapered end or an end of a needle). The tail portion 136 has a proximal end 133 located opposite to the distal end 132. The specified cleaning source of the plurality of pressurized cleaning sources (e.g., 105, 141, 145, 151) can be received from the proximal end 133 of the tail portion 136, and exit from the distal end 132 of the tip portion 135 during the cleaning cycle. In many embodiments, the sample may be aspirated into the tip portion 135 only and the tail portion may be filled with wash buffer so that any sample does not enter and contaminate a fluidic channels of the valve or other parts of the system 10. Also, only the tip portion 135 needs to be thoroughly cleaned, which can be much faster than cleaning an entire lumen 131 of the probe 130.

In many embodiments, the probe wash system 10 can further include a manifold 120 fluidically coupled (e.g., a pipe) to the outlet channel 115 of the valve 110. The manifold 120 can include a first channel (e.g., illustrated in FIG. 3A) couplable to the outlet channel 115 of the valve 110 and direct the specified pressurized cleaning source to the probe 130, and a second channel (e.g., illustrated in FIG. 3A) isolated from the first channel. The second channel may receive input from another mechanism such as an aspiration/dispense mechanism.

FIG. 1 also illustrates an aspiration-dispense system 20 that can be coupled to the manifold 120 or the valve 110 of the probe wash system 10. In some embodiments, the aspiration-dispense system 20 may be deactivated while the probe wash system is active and vice-versa. In some embodiments, the aspiration-dispense system 20 can be configured to aspirate or dispense a sample. The aspiration-dispense system 20 can include a piston pump 165, a wash buffer 161, and optionally a valve 163 to activate or deactivate supply of the wash buffer 161. In the illustrated example, an output of the piston pump 165 can be coupled the second channel of the manifold 120 to pump the wash buffer 161 from the proximal end 133 into the lumen 131 of the probe 130 or to receive suction pressure to aspirate a sample into the tip portion 135 of the probe 130 through the distal end 132. Once, the aspiration and dispense of the sample is complete, the probe wash system 10 can be activated to wash the probe 130 so that inter-sample contamination or cross-contamination can be prevented.

Additionally or alternatively, the probe cleaning system 10 and/or the aspiration-dispense system 20 can include one or more heating elements 146. The heating element 146 may be coupled to fluid line between cleaning sources and the valve 110. For example, the heating element 146 can be coupled to respective fluidic lines between wash buffers (e.g., WB1, . . . , WBn), the cleaning source 151 (e.g., NaOH), the compressed air supply 105, and the valve 110. The pressurized cleaning sources (e.g., 105, 141, 145, and 151) can be at room temperature or be heated using a respective heating element 146 to improve the efficiency of washing of the probe 130. The heating element 146 can be an electronic coil, heated fluid, flame, or other heating sources.

Passing a heated cleaning source to the probe 130 can reduce density of residues (e.g., proteins, or other samples) sticking to the probe 130 making it easy to clean residues. Thus, activating the heating element 146 when passing particular cleaning sources can better and more efficiently clean the probe 130. For example, quality of cleaning can be improved and carry over effect of the samples can be minimized substantially compared to existing probe cleaning systems. In many embodiments, the heating element 146 is activated to maintain temperature of the particular cleaning source within a range of 25° C.-55° C. Heating the fluidic lines and/or the cleaning sources to higher temperatures (e.g., more than 60° C.) may be undesired as high temperatures can affect chemistry associated with sample transfer using the probe 130. As such, maintaining the temperatures of the cleaning sources within a specified range can facilitate improved cleaning, while the probe 130 can be quickly brought to room temperature during sample transfer. In this way, the heating elements 146 can advantageously facilitate improved probe cleaning without interfering with chemistry of sample transfers.

FIG. 2A illustrates an example rotary valve 200, which can be an example of the valve 110. The rotary valve 200 can be configured to implement functionality of the valve 110. For example, in the illustrated embodiment, the valve 200 can include a body 201, a plurality of inlet channels (e.g., 211-214), an outlet channel 220, and a selector 203. Within the body 201, the inlet channels 211-214 can be fluidically coupled to the outlet channel 220. Each inlet channel (e.g., 211-214) can be connected to a specified pressurized cleaning source (e.g., 105, 141, 145, or 151) of the plurality of pressurized cleaning sources (e.g., 105, 141, 145, and 151). For example, a first inlet channel 211 can be fluidically coupled to the compressed air supply 105, a second inlet channel 212 can be fluidically coupled to a first wash buffer WB1, a third inlet channel 213 can be fluidically coupled to the nth (e.g., second) wash buffer WBn, a fourth inlet channel 214 can be fluidically coupled to the NaOH supply 151. Within the body 201, the plurality of inlet channels 211-214 can be isolated from each other. As such, one inlet channel supply only one specified pressurized cleaning supply and another inlet channel supplies another specified pressurized cleaning supply so that the inlet channels are not cross-contaminated.

The selector 203 can be configured to open a specified inlet channel to pass one specified pressurized cleaning source (e.g., 105, 141, 145, or 151) of the plurality of pressurized cleaning sources (e.g., 105, 141, 145, and 151) to the outlet channel 220 at a specified time. The selector 203 can be configured to open one inlet channel at a time while closing other inlet channels so as to avoid intermixing of the plurality of cleaning sources. For example, the selector 203 includes only one opening 204 can be aligned with one of the inlet channels 211-214 so that a specified pressurized cleaning source can be directed to the outlet channel 220. The selector 203 can be configured to receive a sequence of cleaning sources selected from the plurality of the pressurized cleaning sources to be supplied to the probe during the cleaning cycle.

In some embodiments, the selector 203 can be a disk driven by a motor 205. The motor 205 can receive a signal to rotate the selector 203 to open a specified inlet channel to allow a specified pressurized source in a sequence of cleaning sources. For example, the motor 205 can rotate the selector 203 to align the opening 204 with the inlet channel 214 to allow NaOH supply 151 to pass to the outlet channel 220, which further directs the NaOH supply to the probe 130.

FIG. 2B illustrates another example rotary valve 250, which can be an example of the valve 110. The rotary valve 250 includes inlets, an outlet, and a selector. Each inlet channel can be coupled to a cleaning source (e.g., WB1, WB2, WB3, WBn, 105, 151) via a flexible fluid pipe. A centrally disposed outlet channel can be coupled to the probe 130 (or a manifold of FIG. 1) via a flexible fluid pipe. A selector 253 provided to select between positions P1-P6 so that a particular cleaning source can be coupled to the central outlet. When the selector 253 is at a selected position, a corresponding inlet channel is fluidically connected to the outlet channel 220 to allow a cleaning source to enter the outlet channel 220 and further to the probe 130 for cleaning. For example, as shown in FIG. 2C, when the selector 203 is positioned at P1, a first inlet channel is fluidically connected to the outlet channel 220 to allow the cleaning source WB1 to be delivered to the probe 130. Similarly, as shown in FIG. 2D, when the selector 203 is positioned at P2, a second inlet channel is fluidically connected to the outlet channel 220 to allow the cleaning source WB2 to be delivered to the probe 130. Similarly, as shown in FIG. 2E, when the selector 203 is positioned at P4, a fourth inlet channel is fluidically connected to the outlet channel 220 to allow the cleaning source WBn to be delivered to the probe 130.

FIG. 3A is an example manifold 300, which can be an example of the manifold 120 used in the probe cleaning system 10 (in FIG. 1). The manifold 300 includes a manifold body 301. Within the manifold body 301, a first channel 302, a second channel 304 and a third channel 306 may be formed such that the first channel 302 and the second channel 304 are isolated from each other. In an example, the first channel 302 can be coupled to the outlet channel 115 of the valve 110 (in FIG. 1), and the second channel 304 can be coupled to the output of the pump 165 of the aspiration-dispense system 20. When the probe wash system 10 is active, the manifold 300 can facilitate probe cleaning. When the aspiration-dispense system 20 is active, the manifold 300 can facilitate aspiration or dispense of a sample in the probe 130 (in FIG. 1). Thus, the manifold 300 can advantageously achieve multiple functions involved in diagnostic assays, for example, and reduce number of components of a system.

FIG. 3B illustrates a cross-section of another example manifold 310, which can be an example of the manifold 120 used in the probe cleaning system 10 (in FIG. 1). The manifold 310 includes a manifold body 311. Within the manifold body 311, a first channel 312, a second channel 314, and an outlet channel 316 (e.g., extending perpendicular to the plane of the body 311, as shown). One end of the first channel 312 can be coupled to the outlet channel 115 of the valve 110 (in FIG. 1) and another end (within the body 311) can be coupled to the outlet channel 316 so that a cleaning source can be conveyed through the channel 312 to the outlet channel 316 to the probe 130. Similarly, the second channel 314 can fluidically connect another cleaning source to the outlet channel 316 which is fluidically connected to the probe 130. As shown, the first channel 312 and the second channel 314 are isolated from each other so that fluid from one channel (e.g., 312) does not enter into another channel (e.g., 314). As such, cross contamination of the cleaning sources can be prevented.

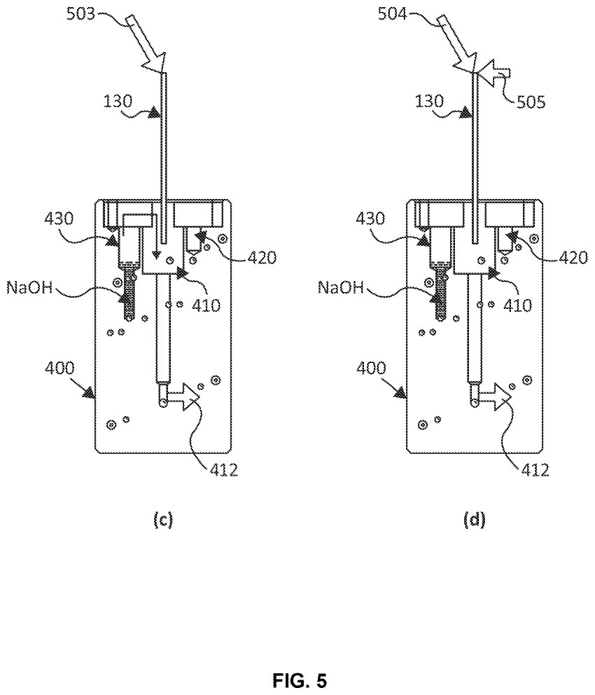

FIG. 4 (a)-(c) illustrate example sequence of probe washing using a probe cleaning system (e.g., the system 10 in FIG. 1). The probe wash can be performed at a clean station, which can be located within a vicinity of samples that are aspirated or dispensed from the probe 130. The clean station can be part of a system that includes probe handler, reagent storage, sample storage, and/or other related assemblies or systems. For example, a multi-analyte detection system can include a reagent storage assembly, a sample handler assembly, a reagent robot, a clean station, and other systems or assemblies. The multi-analyte system may be configured to simultaneously detect multiple analytes in a sample. An example of such system is described in detail in U.S. Pat. No. 8,357,537, which is incorporated by reference herein in its entirety. In many embodiments, the clean station can be configured to implement the probe cleaning system 10 and the aspiration-dispense system 20 of FIG. 1.

In many embodiments, a clean station includes a wash container 400 at which the probe 130 can be washed internally and/or externally using the probe cleaning system 10. In the illustrated examples, the wash container 400 includes a vacuum well 410 configured to receive a portion (e.g., a tip portion) of the probe 130. The vacuum well 410 may be disposed approximately at a center of the wash container 400. The vacuum well 410 has a first end at which the probe 130 can be received and an opposite second end where a suction 412 may be applied to suck away contents from the probe. It is preferred to precisely maintain a vacuum level of the vacuum well 410 so that it does not cause any cavitation in the probe 130 but still strong enough to suck the dispensed cleaning source (e.g., wash buffer) from the vacuum well 410 and/or the side well 420. For example, the contents of the probe can be residual sample, a cleaning source (e.g., a wash buffer, NaOH, or air), or other contents that may be disposed within a lumen of the probe 130. In some embodiments, the wash container 400 can further include one or more side wells (e.g., 420). The side well (e.g., 420) may be positioned adjacent to the vacuum well 410. In some embodiments, the side well 420 may be configured to clean an exterior portion of the probe 130 (e.g., an exterior of the tip portion).

FIG. 4(a) to FIG. 4(c) illustrate example cleaning or wash steps implemented using the probe cleaning system 10. The cleaning steps can include a sequence of cleaning sources applied to the probe 130. Each of the cleaning steps can be applied for a specified period of time so that the entire cleaning or wash cycle can be completed in a specified amount of time (e.g., less than 3 seconds).

In a first step of the cleaning sequence, shown in FIG. 4(a), the probe 130 can be inserted in a hollow portion of the vacuum well 410 without touching walls of the vacuum well 410. Then, the suction 412 may be activated. The suction 412 causes any residual sample or reagent in the lumen of the probe 130 to be sucked away. Thus, the lumen of the probe 130 can be substantially free of any sample or reagent. The suction 412 may be applied to for a first time period e.g., 0.2 seconds. Upon completion of the first step, a second step of the cleaning sequence can commence.

In the second step, shown in FIG. 4(b), a wash buffer 441 can be delivered through the lumen of the probe 130. According to the present disclosure, such wash buffer 441 can be applied by activating a selector (e.g., 112 in FIG. 1 or 203 in FIG. 2) of the valve (e.g., 110 or 200) so that the pressurized wash buffer (e.g., WB1 in FIG. 1) can be passed through the valve and further into the lumen of the probe 130. As the wash buffer (e.g., WB1) is pressurized, upon adjusting the positioning of the selector of the valve to open corresponding inlet channel (e.g., 211), the wash buffer (e.g., WB1) immediately starts flowing through the lumen of the probe 130 thus flushing the interior of the probe 130. The wash buffer (e.g., WB1) can be applied for a second period of time e.g., 0.4 seconds. The wash buffer can wash away any sample or reagents that may be present in the lumen of the probe 130. The suction 412 can also be applied to suck away the wash buffer dispensed through the probe 130. Upon completion of the second step, a third step of the cleaning sequence can commence.

In the third step, shown in FIG. 4(b), air 442 can be pulsated through the lumen of the probe 130. According to the present disclosure, such air 442 pulsations can be supplied by the compressed air supply (e.g., 105 in FIG. 1) via the valve (e.g., 110 in FIG. 1). For example, simply by moving the selector (e.g., 112 in FIG. 1 or 203 in FIG. 2) of the valve (e.g., 110 or 200) to a second inlet channel (e.g., 212) the air supply is connected to the probe 130. The air (e.g., from 105 in FIG. 1) can be pulsated for a second period of time e.g., 0.3 seconds to clear any wash buffer that may be present in the lumen of the probe 130. Upon completion of the third step, a fourth step of the cleaning sequence can commence.

In the fourth step, shown in FIG. 4(b), a wash buffer 443 can be delivered through the lumen of the probe 130. According to the present disclosure, such wash buffer 443 can be same as the wash buffer 441 or another wash buffer (e.g., 145). The wash buffer 443 can be applied in the similar manner as the wash buffer 441. For example, simply by moving the selector (e.g., 112 in FIG. 1 or 203 in FIG. 2) of the valve (e.g., 110 or 200) the pressurized wash buffer (e.g., WBn in FIG. 1) can be passed through the valve and further into the lumen of the probe 130. As the wash buffer (e.g., WBn) is pressurized, upon adjusting the positioning of the selector of the valve to open corresponding inlet channel (e.g., 212), the wash buffer (e.g., WBn) immediately starts flowing through the lumen of the probe 130 thus flushing the interior of the probe 130. The wash buffer (e.g., WB1) can be applied for a fourth period of time e.g., 0.2 seconds. The wash buffer can wash away any sample or reagents that may be present in the lumen of the probe 130. The suction 412 can also be applied to suck away the wash buffer dispensed through the probe 130. Accordingly, the cleaning sequence herein can thoroughly wash the probe 130 so that inter-sample contamination or cross-contamination can be prevented.

FIG. 4(c) illustrate a process of washing an external of the probe 130. As shown, the probe 130 can be maneuvered from the vacuum well 410 to the side well 420. In the side well 420, a wash buffer 445 can be passed through the probe 130 by moving the selector (e.g., 112 in FIG. 1) to open the inlet channel of the valve (e.g., 110) direct the wash buffer (e.g., 141) to the probe 130. The wash buffer 445 can be dispensed through the tip portion of the probe 130 and fill the well 420 so as to wash the exterior surface of the tip portion of the probe 130. Alternatively, the side well 420 can already include a cleaning source for cleaning an external surface of the probe 130 of any residue remaining from transferring a sample (e.g., biological or chemical sample). Thus, in addition to internal lumen cleaning, external surfaces of the probe 130 can also be cleaned to prevent inadvertently cross-contaminating samples. In some embodiments, washing external surface of the probe 130 can involve delivering compressed air 442 so that a cleaning solution in the well 420 can be agitated to better clean the external surface. In some embodiments, the shape of well 420 can allow the wash buffer 445 (e.g., 141 to 145) delivered from the probe 130 to create a turbulence to clean the external of the probe 130. The height of the well 420 can be the maximum probe insertion depth into a sample tube plus approximately 2 mm. For example, an insertion depth can be 3 mm to minimize the required sample dead volume.

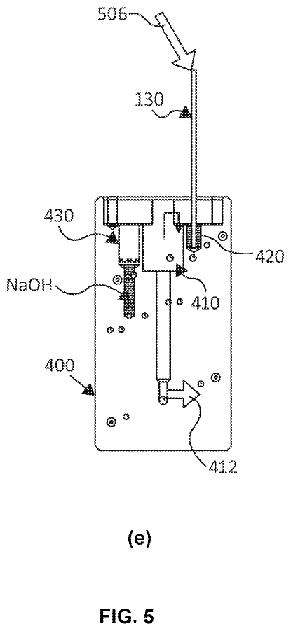

FIG. 5 (a)-(e) illustrate another example sequence of probe cleaning using the probe cleaning system 10 and the aspiration-dispense system 20. In the illustrated example, the probe 130 can be cleaned from both internally and externally. In the illustrated cleaning process, the wash container 400 may include a side well 430 filled with NaOH. The present disclosure is not limited to a particular position, additionally or alternatively, the well 430 for NaOH can be present anywhere along the probe moving path. Each of the cleaning steps can be applied for a specified period of time so that the entire cleaning or wash cycle can be completed in a specified amount of time (e.g., less than 3 seconds).

FIG. 5(a) shows the probe 130 can be positioned in the vacuum well 410 so that any residual reagent or sample can be sucked away from the suction 412. Subsequently, the probe 130 can be moved to the side well 430 to aspirate NaOH into the lumen of the probe 130, as shown in FIG. 5(b). To aspirate NaOH, the aspiration-dispense system 20 can be activated while the probe cleaning system 10 is deactivated. In other words, the pump 165 (in FIG. 1) can be used to aspirate the NaOH into the lumen while the selector (e.g., 112) may be positioned such as none of the inlet channels are connected to the outlet channel. In some embodiments, the valve 110 can be moved to a position where the inlet channel is blocked e.g. the blocked inlet port 114 (in FIG. 1). In another example, the well 430 may be empty and the probe cleaning system 10 can be used to provide NaOH from the probe cleaning supply 151 (in FIG. 1) by moving the selector 112 to open an appropriate inlet channel. As soon as an inlet channel is opened, the NaOH supply 151 will rush into the probe 130 which is faster than using aspiration or pumping action. The NaOH can also be provided to the well 430 using another pump and valve without going through the system 110 and the probe 130. This method may be preferred to avoid any residual NaOH in the probe after cleaning.

After completing the step involving NaOH supply, the probe 130 can be moved to the vacuum well 410, as shown in FIG. 5(c). While in the vacuum well 410, the suction 412 may be applied to remove any reagent 503 or sample within the probe 130. The process of step in FIG. 5(c) can be similar to the process in FIG. 4(a).

Subsequently, as shown in FIG. 5(d), a wash buffer 504 can be passed through the probe 130 and dispensed in the vacuum well 410. The dispensed wash buffer 504 can be sucked away by the suction 412. After washing the probe 130 with the wash buffer 504, air 505 can be pulsated through the probe 130. The process in FIG. 5(d) can be similar to that discussed with respect to FIG. 4(b) and omitted here for brevity. Accordingly, the probe 130 can be cleaned from interior of the probe 130.

After the internal cleaning of the probe 130, an exterior of the probe 130 can be cleaned. For example, as shown in FIG. 5(e), the probe 130 can be moved from the vacuum well to another side well 420 without touching walls of the side well 420. In the side well 420, a wash buffer 506 can be passed through the probe 130 by moving the selector (e.g., 112 in FIG. 1) to open the inlet channel of the valve (e.g., 110) direct the wash buffer (e.g., 141) to the probe 130. The wash buffer 506 can be dispensed through the tip portion of the probe 130 and fill the well 420 so as to wash the exterior surface of the tip portion of the probe 130. Alternatively, the side well 420 can already include a cleaning source for cleaning an external surface of the probe 130 of any residue remaining from transferring a sample (e.g., biological or chemical sample). Thus, in addition to internal lumen cleaning, external surfaces of the probe 130 can also be cleaned to prevent inadvertently cross-contaminating samples. In some embodiments, washing external surface of the probe 130 can involve delivering compressed air so that a cleaning solution in the well 420 can be agitated to better clean the external surface. In some embodiments, the shape of well 420 can allow the wash buffer (e.g., 141 to 145) delivered from the probe 130 to create a turbulence to clean the external of the probe 130. The height of the well 420 can be the maximum probe insertion depth into a sample tube plus approximately 2 mm. For example, an insertion depth can be 3 mm to minimize the required sample dead volume.

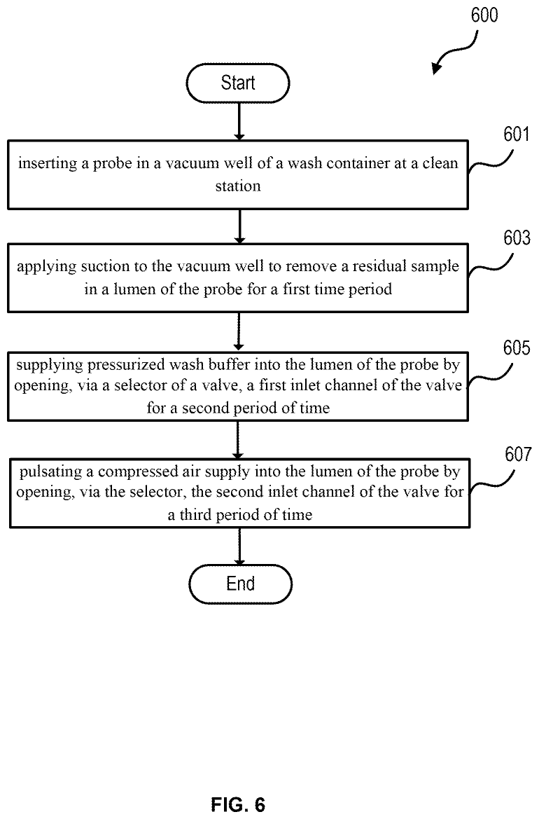

FIG. 6 is a flow chart of a method 600 of cleaning a probe using a probe cleaning system, according to embodiments of the present disclosure. For example, as discussed herein, the probe cleaning system 10 can include the plurality of pressurized cleaning sources (e.g., 105, 141, 145, 151 in FIG. 1) including a pressurized wash buffer (e.g., 141) and a compressed air supply (e.g., 105), a valve (e.g., 110). As discussed, the valve (e.g., 110) includes a plurality of isolated inlet channels including a first inlet channel coupled to the pressurized wash buffer (e.g., 141) and a second inlet channel coupled to the compressed air supply (e.g., 105), and a selector (e.g., 112) to open or close a specified inlet channel. The method 600 involves steps 601-607, further discussed in detail below.

Step 601 can involve inserting a probe in a vacuum well of a wash container at the clean station. For example, as shown in FIG. 4(a), the probe 130 can be inserted in the vacuum well 410 of the wash container 400. The probe 130 can be positioned such that a tip portion of the probe is suspended in an empty portion of the vacuum well. The probe 130 can be suspended such that exterior of the probe 130 does not touch walls of the wash container 400.

Step 603 involves applying suction to the vacuum well to remove a residual sample in a lumen of the probe for a first time period. For example, as shown in FIG. 4(a), the wash container 400 can facilitate draining of the contents in the probe 130. For example, at a bottom end of the vacuum well 410, a suction 412 can be applied so that any residual sample or contents of the probe 130 can be removed. In some embodiments, vacuum in the well 420 can be strong enough to minimize the wash buffer remaining in the well 420. The lumen (e.g., 131 illustrated in FIG. 1) can include residual sample from a sample transfer step. Most of such residual sample can be removed via the suction. Although some sample may remain, which can be removed by more thorough washing of the probe 130, as follows.

Step 605 involves supplying the pressurized wash buffer into the lumen of the probe by opening, via the selector, the first inlet channel of the valve for a second period of time. For example, referring to FIGS. 1 and 4(b), the pressurized wash buffer WB1 is supplied through to the lumen 131 of the probe 130. The selector 112 can be moved within the valve 110 such that the first inlet channel fluidically coupled to the wash buffer WB1 is opened. The pressure of the pressurized wash buffer WB1 causes the wash buffer WB1 to rush through the inlet channel to the outlet channel 115 and further into the lumen 131 of the probe 130. The wash buffer WB1 can be discharged into the vacuum well 410 which can be further sucked away by the suction 412 (in FIG. 4). Accordingly, the lumen of the probe 130 can be washed by the wash buffer to remove even small amount of residual sample that may be present in the probe 130.

Step 607 involves pulsating the compressed air supply into the lumen of the probe by opening, via the selector, the second inlet channel of the valve for a third period of time. For example, FIGS. 1 and 4(b), the selector 112 can be moved to open the second inlet channel of the valve 110 so that the compressed air supply 105 can be pulsated through the lumen 131 of the probe 130. Such pulsating action can remove any wash buffer in the probe 130 and any small residual sample.

In some embodiments, the method 600 can further involve subsequent to pulsating of the compressed air supply, resupplying the pressurized wash buffer into the lumen of the probe by opening the first inlet channel of the valve for a fourth period of time. For example, FIGS. 1 and 4(c), the wash buffer 141 or 145 can be supplied by moving the selector 112 of the valve 110 to open the first inlet channel. The pressurized wash buffer WB1 can rush through the probe 130 and be discharged in the wash container 400 while removing any small residual of the sample. Such multiple passes of the cleaning sources ensure the probe 130 is thoroughly cleaned. Further, the method 600 can involve withdrawing the probe (e.g., 130) from the wash container (e.g., 400).

In some embodiments, the method 600, further involves, subsequent to pulsating of the compressed air supply or subsequent to supplying the pressurized wash buffer, supplying a pressurized NaOH into the lumen of the probe by opening a third inlet channel of the valve for a fifth period of time. For example, referring to FIG. 1, the NaOH supply 151 may be connected to a third inlet channel of the valve 110. The selector 112 can be moved to open the third inlet channel so that the NaOH supply can be delivered under pressure to the probe 130.

In some embodiments, the method 600 can further involve, subsequent to cleaning the probe, activating an aspiration dispense system coupled to the valve. For example, as shown in FIG. 1, the aspiration dispense system 20 can include the piston pump 165 coupled to a fourth inlet channel of the valve (not illustrated) or to a channel of the manifold 120 (shown in FIG. 1). Further, a specified amount of sample can be aspirated from a sample container into the lumen of the probe by opening a fourth inlet channel of the valve or through the manifold 120 and activating the piston pump 165. The sample can be aspirated only in a tip portion (e.g., 135) of the probe (e.g., 130) and a wash buffer can occupy a remaining portion of the probe so that an entire lumen of the probe is not contaminated with the sample

In some embodiments, activating the aspiration dispense system can involve closing, via the selector (e.g., 112 in FIG. 1), all the inlet channels of the valve (e.g., 110) that are coupled to the cleaning sources (e.g., 105, 141, 145, 151) before aspirating the specified amount of sample. The method 600 can further involve supplying another wash buffer (e.g., 161 in FIG. 1) into the lumen of the probe via the piston pump (e.g., 165 in FIG. 1). The piston pump can further pump the wash buffer into the probe (e.g., 130). Supplying the another wash buffer can involve activating the compressed air supply of the probe cleaning system to drive the another wash buffer through the piston pump and the valve into the lumen of the probe. The another wash buffer (e.g., 161) can be coupled to the piston pump (e.g., 165) such that the piston pump can receive the wash buffer (e.g., 161 by compressed air supply 105 pushing the wash buffer into the piston pump 165).

### EXAMPLES

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and the present disclosure is not limited to these example examples but rather encompasses all possible modifications and variations within the scope of the issued claims and their equivalents.

Example 1. A probe cleaning system comprising: a plurality of pressurized cleaning sources; a valve comprising a plurality of inlet channels, an outlet channel, and a selector, wherein each inlet channel is connected to a specified pressurized cleaning source of the plurality of pressurized cleaning sources, wherein the plurality of inlet channels are isolated from each other, wherein the selector is configured to open a specified inlet channel to pass one specified pressurized cleaning source of the plurality of pressurized cleaning sources to the outlet channel at a specified time; and a probe coupled to the outlet channel of the valve to receive the specified pressurized cleaning source when the specified inlet channel of the valve is opened during a cleaning cycle.

Example 2. The system of any of the preceding or subsequent examples or combination of examples, wherein the plurality of pressurized cleaning sources comprises: one or more wash buffers; and a compressed air supply.

Example 3. The system of any of the preceding or subsequent examples or combination of examples, wherein the compressed air supply is coupled to each of the plurality of pressurized cleaning sources to drive the specified pressurized cleaning source through the specified inlet channel.

Example 4. The system of any of the preceding or subsequent examples or combination of examples, wherein the compressed air supply is directly fluidically coupled to one of the plurality of inlet channels.

Example 5. The system of any of the preceding or subsequent examples or combination of examples, wherein the compressed air supply is configured to pulse air through the probe at a specified pulse rate.

Example 6. The system of any of the preceding or subsequent examples or combination of examples, wherein the plurality of pressurized cleaning sources further comprises an NaOH supply.

Example 7. The system of any of the preceding or subsequent examples or combination of examples, wherein the selector is configured to receive a sequence of cleaning sources selected from the plurality of the pressurized cleaning sources to be supplied to the probe during the cleaning cycle.

Example 8. The system of any of the preceding or subsequent examples or combination of examples, wherein each cleaning source of the sequence of cleaning sources is activated at a specified time so that an entire sequence of cleaning sources is completed within a specified time period.

Example 9. The system of any of the preceding or subsequent examples or combination of examples, wherein the specified time period of the cleaning cycle is less than 3 seconds.

Example 10. The system of any of the preceding or subsequent examples or combination of examples, wherein the inlet channels of the valve has negligible to zero dead volume configured such that one pressurized cleaning source is prevented from leaking in another pressurized cleaning source when the valve switches between the plurality of pressurized cleaning sources.

Example 11. The system of any of the preceding or subsequent examples or combination of examples, wherein the valve is a rotary valve comprising the plurality of inlet channels and the selector drivable via a motor.

Example 12. The system of any of the preceding or subsequent examples or combination of examples, wherein the probe comprises a lumen, and one or more of the pressurized cleaning sources are passed through the lumen of the probe to clean an interior of the probe.

Example 13. The system of any of the preceding or subsequent examples or combination of examples, wherein the probe comprises: a tip portion for receiving a sample; and a tail portion extending away from the tip portion, wherein the specified cleaning source of the plurality of pressurized cleaning sources is receivable from the tail portion, and exit from the tip portion during the cleaning cycle.

Example 14. The system of any of the preceding or subsequent examples or combination of examples, further comprising a wash container, the wash container comprising: a vacuum well configured to receive the probe and suck away the specified pressurized cleaning source dispensed from the probe causing interior cleaning of the probe.

Example 15. The system of any of the preceding or subsequent examples or combination of examples, wherein the wash container comprises: a side well configured to clean an exterior portion of the probe.

Example 16. The system of any of the preceding or subsequent examples or combination of examples, further comprising a manifold, the manifold comprising: a first channel coupled to the outlet channel of the valve and direct the specified pressurized cleaning source to the probe; and a second channel isolated from the first channel.

Example 17. The system of any of the preceding or subsequent examples or combination of examples, further comprises: an aspiration-dispense comprising a piston pump and a wash buffer, wherein the second channel is coupled to the piston pump to direct wash buffer into the probe or receive suction pressure to aspirate a sample into a tip portion of the probe.

Example 18. The system of any of the preceding or subsequent examples or combination of examples, wherein the selector is configured to open one inlet channel at a time while closing other inlet channels so as to avoid intermixing of the plurality of cleaning sources.

Example 19. The system of any of the preceding or subsequent examples or combination of examples, further comprising: a heating element coupled to a fluid line connecting a cleaning source of the plurality of pressurized cleaning sources to the valve, the heating element configured to heat the cleaning source within a specified temperature range before delivering to the cleaning source to the probe.

Example 20. A method of probe cleaning at a clean station using a probe cleaning system, the probe cleaning system comprising a plurality of pressurized cleaning sources including a pressurized wash buffer and a compressed air supply, a valve comprising a plurality of isolated inlet channels including a first inlet channel coupled to the pressurized wash buffer and a second inlet channel coupled to the compressed air supply, and a selector to open or close a specified inlet channel, the method comprising: inserting a probe in a vacuum well of a wash container at the clean station; applying suction to the vacuum well to remove a residual sample in a lumen of the probe for a first time period; supplying the pressurized wash buffer into the lumen of the probe by opening, via the selector, the first inlet channel of the valve for a second period of time; and pulsating the compressed air supply into the lumen of the probe by opening, via the selector, the second inlet channel of the valve for a third period of time.

Example 21. The method of any of the preceding or subsequent examples or combination of examples, further comprising: subsequent to pulsating of the compressed air supply, resupplying the pressurized wash buffer into the lumen of the probe by opening the first inlet channel of the valve for a fourth period of time; and withdrawing the probe from the wash container.

Example 22. The method of any of the preceding or subsequent examples or combination of examples, further comprising: subsequent to pulsating of the compressed air supply or subsequent to supplying the pressurized wash buffer, supplying a pressurized NaOH into the lumen of the probe by opening a third inlet channel of the valve for a fifth period of time.

Example 23. The method of any of the preceding or subsequent examples or combination of examples, further comprising: subsequent to cleaning the probe, activating an aspiration dispense system coupled to the valve, the aspiration dispense system comprising a piston pump coupled to the lumen of the probe; and aspirating a specified amount of sample from a sample container into the lumen of the probe by activating the piston pump.

Example 24. The method of any of the preceding or subsequent examples or combination of examples, wherein the piston pump of the aspiration dispense system is coupled to a fourth inlet channel of the valve, wherein the aspirating comprises opening the fourth inlet channel.

Example 25. The method of any of the preceding or subsequent examples or combination of examples, wherein the piston pump of the aspiration dispense system is coupled to a manifold.

Example 26. The method of any of the preceding or subsequent examples or combination of examples, wherein activating the aspiration dispense system comprises: closing, via the selector, all the inlet channels of the valve before aspirating the specified amount of sample.

Example 27. The method of any of the preceding or subsequent examples or combination of examples, further comprising: supplying another wash buffer into the lumen of the probe via the piston pump, wherein the another wash buffer is coupled to the piston pump.

Example 28. The method of any of the preceding or subsequent examples or combination of examples, wherein supplying the another wash buffer comprises: activating the compressed air supply of the probe cleaning system to drive the another wash buffer through the piston pump and into the lumen of the probe, wherein the compressed air supply is coupled to the another wash buffer.

Example 29. The method of any of the preceding or subsequent examples or combination of examples, wherein the sample is held in a tip portion of the probe and a wash buffer occupies a remaining portion of the probe so that an entire lumen of the probe is not contaminated with the sample.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

1. A probe cleaning system comprising:
a plurality of pressurized cleaning sources;
a valve comprising a plurality of inlet channels, an outlet channel, and a selector, wherein each inlet channel is connected to a specified pressurized cleaning source of the plurality of pressurized cleaning sources, wherein the plurality of inlet channels are isolated from each other, wherein the selector is configured to open a specified inlet channel to pass one specified pressurized cleaning source of the plurality of pressurized cleaning sources to the outlet channel at a specified time; and
a probe coupled to the outlet channel of the valve to receive the specified pressurized cleaning source when the specified inlet channel of the valve is opened during a cleaning cycle.

2. The system of claim 1, wherein the plurality of pressurized cleaning sources comprises:
one or more wash buffers; and
a compressed air supply.

3. The system of claim 2, wherein the compressed air supply is coupled to each of the plurality of pressurized cleaning sources to drive the specified pressurized cleaning source through the specified inlet channel.

4. The system of claim 2, wherein the compressed air supply is directly fluidically coupled to one of the plurality of inlet channels.

5. The system of claim 2, wherein the compressed air supply is configured to pulse air through the probe at a specified pulse rate.

6. The system of claim 2, wherein the plurality of pressurized cleaning sources further comprises an NaOH supply.

7. The system of claim 1, wherein the selector is configured to receive a sequence of cleaning sources selected from the plurality of the pressurized cleaning sources to be supplied to the probe during the cleaning cycle.

8. The system of claim 7, wherein each cleaning source of the sequence of cleaning sources is activated at a specified time so that an entire sequence of cleaning sources is completed within a specified time period.

9. The system of claim 8, wherein the specified time period of the cleaning cycle is less than 3 seconds.

10. The system of claim 1, wherein the inlet channels of the valve has negligible to zero dead volume configured such that one pressurized cleaning source is prevented from leaking in another pressurized cleaning source when the valve switches between the plurality of pressurized cleaning sources.

11. The system of claim 1, wherein the valve is a rotary valve comprising the plurality of inlet channels and the selector drivable via a motor.

12. The system of claim 1, wherein the probe comprises a lumen, and one or more of the pressurized cleaning sources are passed through the lumen of the probe to clean an interior of the probe.

13. The system of claim 12, wherein the probe comprises:
a tip portion for receiving a sample; and
a tail portion extending away from the tip portion,
wherein the specified cleaning source of the plurality of pressurized cleaning sources is receivable from the tail portion, and exit from the tip portion during the cleaning cycle.

14. The system of claim 1, further comprising a wash container, the wash container comprising:
a vacuum well configured to receive the probe and suck away the specified pressurized cleaning source dispensed from the probe causing interior cleaning of the probe.

15. The system of claim 14, wherein the wash container comprises:
a side well configured to clean an exterior portion of the probe.

16. The system of claim 1, further comprising a manifold, the manifold comprising:
a first channel coupled to the outlet channel of the valve and direct the specified pressurized cleaning source to the probe; and
a second channel isolated from the first channel.

17. The system of claim 16, further comprises:
an aspiration-dispense comprising a piston pump and a wash buffer,
wherein the second channel is coupled to the piston pump to direct wash buffer into the probe or receive suction pressure to aspirate a sample into a tip portion of the probe.

18. The system of any claim 1, wherein the selector is configured to open one inlet channel at a time while closing other inlet channels so as to avoid intermixing of the plurality of cleaning sources.

19. The system of claim 1, further comprising:
a heating element coupled to a fluid line connecting a cleaning source of the plurality of pressurized cleaning sources to the valve, the heating element configured to heat the cleaning source within a specified temperature range before delivering to the cleaning source to the probe.

20. A method of probe cleaning at a clean station using a probe cleaning system, the probe cleaning system comprising a plurality of pressurized cleaning sources including a pressurized wash buffer and a compressed air supply, a valve comprising a plurality of isolated inlet channels including a first inlet channel coupled to the pressurized wash buffer and a second inlet channel coupled to the compressed air supply, and a selector to open or close a specified inlet channel, the method comprising:
inserting a probe in a vacuum well of a wash container at the clean station;
applying suction to the vacuum well to remove a residual sample in a lumen of the probe for a first time period;
supplying the pressurized wash buffer into the lumen of the probe by opening, via the selector, the first inlet channel of the valve for a second period of time; and
pulsating the compressed air supply into the lumen of the probe by opening, via the selector, the second inlet channel of the valve for a third period of time.

21.-29. (canceled)
